(19) United States
(12) Patent Application Publication
(10) Pub. No.: US 2019/0102853 A1
(43) Pub. Date: Apr. 4, 2019

(54) SYSTEM AND METHOD FOR PROVIDING PERSONALIZED ACADEMIC COUNSELING USING A MOBILE DEVICE

(71) Applicants: Peter Ratzan, Weston, FL (US); Jill Ratzan, Weston, FL (US)

(72) Inventors: Peter Ratzan, Weston, FL (US); Jill Ratzan, Weston, FL (US)

(21) Appl. No.: 15/724,602

(22) Filed: Oct. 4, 2017

(51) Int. Cl. G06Q 50/20; G06F 17/30; G06Q 10/10; H04L 29/08

(52) U.S. Cl. CPC G06Q 50/2053; G06F 17/30126; H04L 63/105; H04L 67/306; G06Q 10/1097

(57) ABSTRACT

The embodiments disclosed provide a system and method for providing academic counseling resources between an academic counselor and student using a mobile device. The system includes a microprocessor, memory, interface, mobile app server, and GUI which provides a plurality of categorized folder to both the student user and counselor containing assigned tasks, timelines, media files, college/university profile information while simultaneously allowing messaging. The system is configured to provide a student user a pre-programmed academic profile corresponding to their academic grade level which includes a variety of folders accessible using an icon.

### FIELD

The present embodiments relate to a system and method for providing personalized counseling services, and in particular a system and method which enables academic counseling between an academic counselor and student using a mobile device.

### BACKGROUND

School counselors have limited resources and available time to serve the needs of their high caseloads. With an average of 1 counselor serving 491 students, there is simply not enough time in the day to reach every student and deliver proper college guidance. YCC360 not only gives counselors an integrated and secure messaging platform where s/he can communicate with one, many, or all students, but it also provides a delivery mechanism for built-in college access curricula so that students receive timely content on what they need in order to meet deadlines. Prior art tools that track application submissions have no ability to direct high school students on the tasks that they need to complete throughout the academic calendar to remain on task: i.e., standardized test registration, essay completion, financial aid filing deadlines; application deadlines; college fair notification, etc.

With college degrees becoming increasingly essential in the workplace, students are being primed and groomed earlier than ever for the rigors of gaining admission to a preferred university or college. As students' progress through their pre-collegiate academic years, there are important periods, deadlines, and goals that need to be maintained and planned for in order to optimize the student's success, all of which varies and changes for students through each academic level. While the role of advising and following up with students' preparations has typically been assumed by a School Counselor, the pragmatic difficulty of maintaining ongoing relations, following up, and coaching every student under that Counselor can lead to a deficit in the care some students require to succeed.

With personal computing devices becoming more prevalent among society, including younger generations, it has become a practical solution for the Counselors to convey information and manage their students via a digital platform. Although traditional electronic messaging and calendaring systems are known in the art, it remains incumbent upon the administrator of such systems to manually add and maintain entries and to follow up to monitor progress.

School Counselors would benefit from a system that can allow the counselor both individual communication and larger scale batch presentation of information, with bi-directional monitoring of progress to keep both the counselor and student informed of overall progress. With the ability to have customized schedules and tasks, which can be tailored to the student based on individual need and academic level, the counselor and student alike can follow along with the student's progress without the need to interrupt the school day or compete for a scheduled appointment. Moreover, while traditional database systems allow for collaborative access to various files, the counseling process would benefit from a system wherein resources are made available to correspond with particular events, schedules, or requests automatically or categorically en masse.

Currently there are several systems and methods which disclose aspects of providing academic counseling services such as U.S. Pat. App. No. 2015/0019453 to Mebane; U.S. Pat. App. No. 2015/0050631 to College Zoom, Inc.; and U.S. Pat. App. No. 2009/0083048 to Mandelbaum. However, these references do not disclose a system and method which allow for interactive and personalized college counseling.

### SUMMARY OF THE INVENTION

The present embodiments provide an interactive college counseling system and method of use on a mobile device which enables efficient academic counseling and management between a student user, academic counselor, and authorized third-party participant using a mobile device. The system includes a microprocessor, memory module, network interface, and Graphical User Interface (GUI) which allow the student user, counselor, and third-party administrator to navigate the variety of downloaded files and resources contained within their respective folders. The system and method are configured to provide long-term academic counseling and management in preparing for college. The system allows the student to strategically plan for standardized tests, college essays, and academic interviews while simultaneously providing an “academic roadmap” with including best practice and tips for college/university preparation success.

The system allows both an administrator and student user to login to the system with unique system administrator authorized credentials and view a dashboard including a variety of academic tasks, media files, timelines, and college/university resources which enable both a student user and parent to financially prepare and manage the student application process. The system further allows for messaging between the student, counselor, and authorized third-party to ensure an efficient flow of communication and information is readily available to facilitate the continued navigation of the academic process.

The student user dashboard will further include a variety of folders containing academic information tailored to the student's academic level. The student user will then be able to select and view the contents of the folder by tapping on the desired folder to manage received tasks, timelines, and academic media files designed to aid the student in selecting and preparing the rigorous application process while simultaneously allowing authorized participants to stay informed throughout the student user academic preparation.

The counselor dashboard will provide a list of students assigned by the system administrator which may be further categorized by grade level. The dashboard will allow the counselor to transmit and receive messages from a student user to inform them of upcoming deadlines and new tasks that are viewable on the student user calendar.

The GUI and microprocessor allow both the administrator and student to select, drop, and drag messages, media files, and tasks to both pre-determined categorized folders containing files corresponding to the student user academic profile. The GUI further provides interactive functionality by allowing the student to select specific files, mark tasks as completed, scroll through lists, and send/receive electronic messages.

The embodiments further provide a method of implementing the above-mentioned system including receiving the academic information for a variety of students from a school counselor or authorized third-party participants. Once the information including the name and academic grade-level is received and determined, both the student user and academic counselor will receive login credentials from the system administrator. The student user and counselor will be able to view “Dashboard” which contains a variety of academic information and resources which further enable both parties to manage specific tasks and timelines. The student user will have a pre-determined academic profile corresponding to their academic grade populated and viewable on their mobile device.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an exemplary view of a system for providing personalized college counseling services;

FIG. 2 is a diagram depicting the control architecture of the system;

FIG. 3 is a block diagram of the system and components;

FIG. 4 is a view of a window depicting the student ‘Timeline’ screen;

FIG. 5 is a view of a window depicting the student ‘To-dos’ screen;

FIG. 6 is a view of a window depicting the student ‘Messaging’ screen;

FIG. 7 is a view of ‘ELocker’ screen including contained folders;

FIG. 8 is a view of downloaded file within the contained folder of the ‘ELocker’ categorized folder;

FIG. 9 is a view of a window depicting the student ‘Toolkit’ screen;

FIG. 10 is a view of a window depicting the student ‘Profile’ screen;

FIG. 11 is a view of a window depicting the counselor ‘Dashboard’ screen;

FIG. 12 is a view of a window depicting the counselor ‘Messaging” screen, under the option ‘Students’; and

FIG. 13 is a further view of a window depicting the counselor ‘Messaging’ screen, under the option ‘Groups.’

### DETAILED DESCRIPTION

Before describing in detail exemplary embodiments, it is noted that the embodiments reside primarily in combinations of apparatus components and processing steps related to providing academic counseling services between at least a student user and academic user in a computer system using a mobile system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Traditionally, school counselors and consultants have used various measuring tools to track the progress of a student as they matriculate such as SAT scores, GPA, College Preparation Courses/Honors grades, and extracurricular activities when assessing college and university selection criteria. Though these data points provide a baseline assessment they do not provide personalized guidance to students which is critical in capturing a student's unique interests and experiences. These traditional methods generally utilize a basic consultation (i.e., intake) between the student counselor and student during the first few weeks of their transition into high school. The student's information is generally captured on an intake form which asks the student about their academic background including academic goals, extracurricular activities, interests, personality traits, and any unique attributes. This intake usually conducted very early in the student's academic career is then the foundation for identifying and matching colleges/universities and potential programs. However, with many overpopulated schools, this task becomes unmanageable for a counseling department and the process quickly transitions into a “one size fits all” methodology with many tasks and timelines being overlooked or forgotten.

The embodiments provided include a college counseling management system which includes a combination of integrated college planning resources uniquely designed to help college-bound middle and high school students research, prepare for, gain acceptance to, and graduate from college with a degree that they can use, without the burden of excessive student debt. The system further provides both students and parents a manner of tracking important academic tasks on a timeline to ensure that all academic milestones are met. Further, the system's messaging module ensures that student user, counselors, and parents are able to quickly and efficiently communicate and collaborate through the user-friendly mobile application.

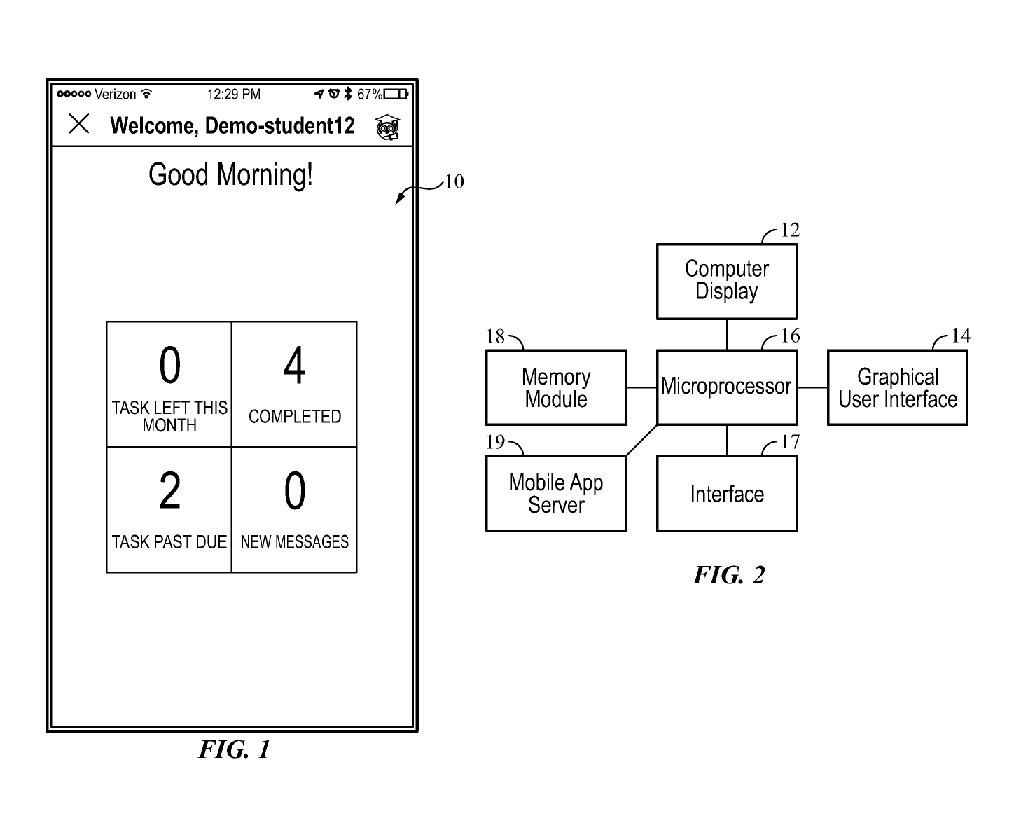

Referring now to the drawings where it is a shown in FIG. 1 a system for providing academic counseling using a mobile device 10. In the current embodiment, the system 10 displays the Counselor ‘Dashboard” immediately after entering the login and password provided by the system administrator. Further illustrated in FIG. 1 is a view of the software application installed and used on a mobile device (i.e., smartphone). It is contemplated the mobile application may be downloaded from a mobile web browser or major app stores such as “Google Play” for Android and App Store for iOS operating systems.

FIG. 2 is a diagram depicting the control architecture of the system 10 configured to implement the computer program described above. The computer displays 12, a graphical user interface (GUI) 14 implemented by a processor 16, a memory 18, and an interface 17. The memory 18 may store software instructions that, when executed by the processor 16, cause the processor 16 to perform the functions and acts described above. The system mobile app server 19 provides back-end support to the mobile user interface which further enables data routing, authentication between the user and the system administrator, authorizations, allows the user to work off-line, and enables the system 10 to be used on the mobile device.

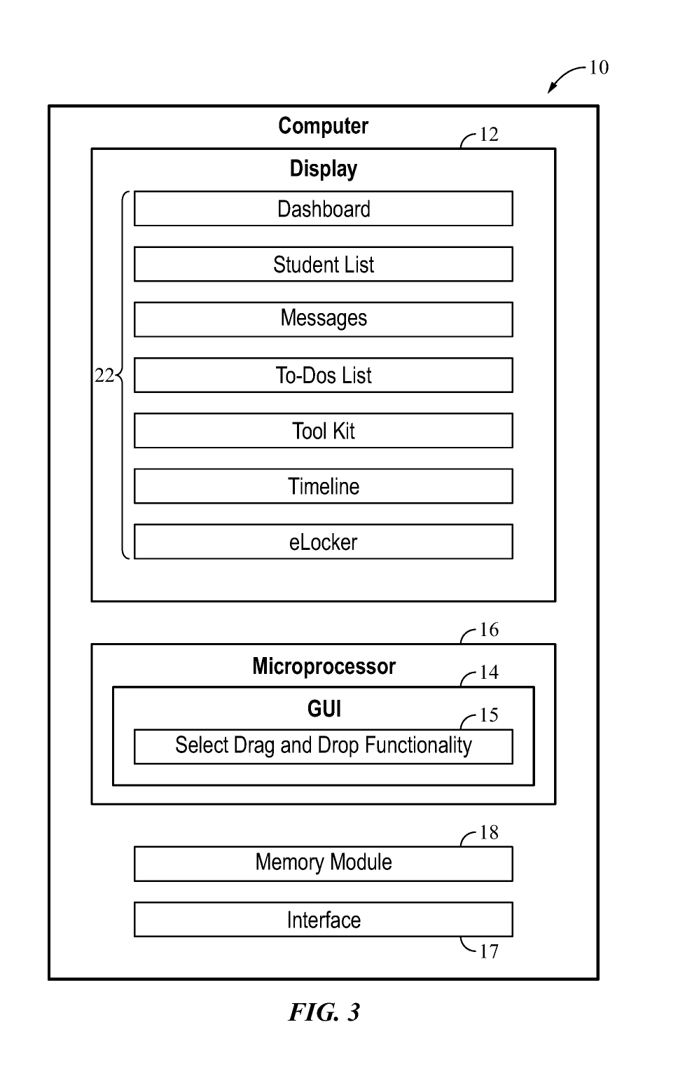

Shown in FIG. 3 is block diagram of the system 10 including the computer display 12 which enables the user to view the categorized folders 22, each with its own unique and icon located at the bottom of the display which may be interacted with by student user, counselor, or third-party participant by way of the mobile user interface 17 which allows for touch-based selection (i.e., tapping) with a finger. Further illustrated in FIG. 3 is the plurality of categorized folders 22, each containing separate file folders and downloaded files.

The microprocessor 16 enables the student user to login to the system 10, after receiving authentication from the system administrator, and view their own academic profile further classified into individual categorized folders: ‘Dashboard’150, ‘Messages’250, ‘To-dos List’ 350, ‘Tool Kit’450, ‘Timeline’ 550, and ‘ELocker’ 650, displayed at the bottom of the screen. The student user's academic profile corresponds to a student user academic grade level which is received from an academic counselor or admin authorized participant such as a non-profit organization or charity. For example, a school's academic counselor may send the system administrator a list of student names including each student's academic grade level which then prompts the administrator to create for each student user a unique login authentication. The student is then able to log in and view a pre-programmed academic profile stored within the microprocessor and integrated memory module 18. The pre-programmed academic profile corresponds to the specific student users academic grade level where a pre-determined set of tasks, timelines, lists, and media files are contained within the plurality of categorized folders 22.

The microprocessor 16 and integrated memory module 18 further enable a counselor or admin authorized participant to log in using their unique authentication and view a ‘Dashboard’ which may be further sorted by student academic grade level, students with tasks overdue, and students “on schedule” as further illustrated in FIG. 11.

The memory module 18 includes a variety of stored data including media files, college/university listings and financial data, and a plurality of academic profiles. Once a student user is identified with their corresponding academic grade level, a pre-determined academic profile corresponding to the student user academic grade level is assigned. For example, a new high school student in the 9^{th} grade who has downloaded the mobile app and logged into the system 10 be will have a pre-programmed academic profile tailored for 9^{th} graders. The tasks, timeline, files, and misc. data is designed to accommodate the student who has several years of high school remaining. At the same time, an 11^{th} grader would have a different and much more compressed academic profile which is designed to account for shortened period until high school graduation.

The Graphical User Interface 14 is configured to allow the student user, counselor, and admin authorized participants to be able to select a categorized folder by tapping an icon or selecting a specific file by tapping the file name. The GUI 14 is further configured to enable the student user to tap a date on the calendar containing a chronologically numbered notification to view the specific tasks or notes associated. Further, the GUI 14 enables the users to select, drop and drag 15 files.

The Mobile Application (App) server 19 is configured to provide accessibility from the back-end to the mobile application to support the mobile application and enable implementing the business logic. The server provides security, data routing, and management and may be deployed through the Cloud, Private Cloud, Platforms as a Service, or on premises.

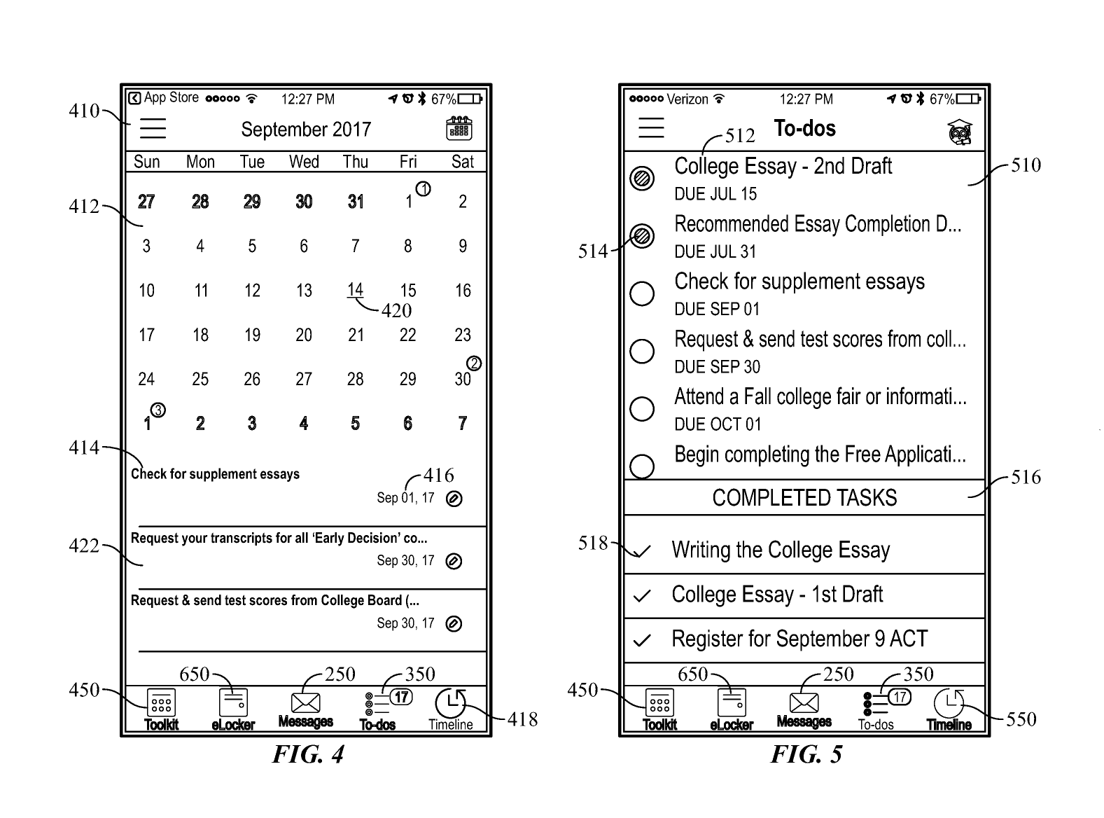

Shown in FIG. 4 is a view of the student ‘Timeline’ screen 410 which includes a viewable calendar 412 and list of tasks 414 with corresponding deadlines 416. The timeline screen 410, which may be accessed by selecting the ‘Timeline’ folder 418 located at the bottom of the screen. The ‘Timeline’ folder 418 is designed to assist student users and authorized participants in quickly ascertaining due dates and upcoming tasks 414 on the viewable calendar 412. Once ‘Timeline’ folder 418 is selected, the calendar 412 will appear and further provide an “underscore” indicator 420 below the applicable date. In the current example, the underscore indicator 420 is placed on “Thursday, Sep. 14, 2017.” The calendar 412 allows the Counselor to highlight specific tasks 414 with due dates using a numerical indicator 420. Further, the student user may customize the calendar 412 to add events and reminders which appear on both the calendar and list of tasks 414. The list of tasks 414 may be further shown in a vertical column 422 below calendar 412. Located adjacent to the list of tasks 414 is the corresponding due date 416. In the present example, a student user or parent could easy tap the ‘Timeline” folder, view the calendar 412, and see an encircled number “1” on “Sep. 1, 2017.” The student understanding that a task 414 is due on Sep. 1, 2017, may then view the vertical column 422 below to learn the task 414 “Check for supplement essays” is due. Have been prompted by the numerical indicator 412, the student user may then view items within the ‘Tool Kit’ or ‘ELocker’ categorized folder for further instructions or tips for reviewing the supplemental essay.

Shown in FIG. 5 is a view of the student “To-Do” screen 510 which provides detailed “To-dos” items 512 chronologically displayed in a vertical list. Further located next to each of the To-dos items 512 is fillable bubble 514 which may be filled (i.e., highlighted) by tapping the screen over the fillable bubble 514 which may be marked to indicate completion, progress, and urgency in the related task. Further illustrated is a “Completed Task” list 516 located directly below the To-do list 512 which provides a list of completed items with a “check” 518 indicators next to each item. In this particular example, the To-do list 512 indicates “College Essay-2^{nd} Draft” with the fillable bubble 512 marked. Further illustrated is the ‘To-dos” folder

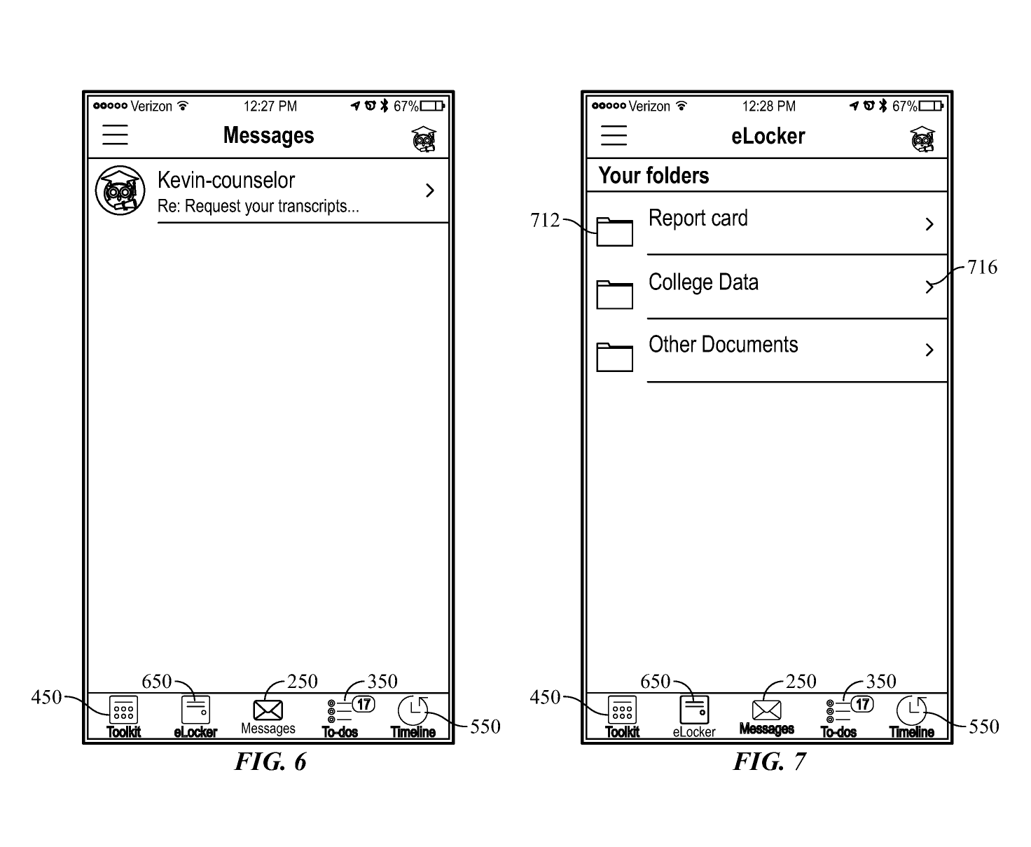

Shown in FIG. 6 is a view of the student ‘Messaging’ screen 510 which may be accessed by selecting the ‘Messages” categorized folder 250. Note that embodiments can interface with preexisting text message programs such as Microsoft Outlook® to add the functionality described above to the preexisting messaging program. Thus, an embodiment of message categorization code having the functionality described herein can be stored on a disc and inserted into a disc reader and loaded onto a computer that already has messaging software stored thereon. The message categorization program as described above may interact with the preexisting messaging program to cause a display of categories at the top of the usual display of the preexisting messaging program and will enable the user to select and drop messages from a message list into a category as described above.

The processor 16 implements the GUI 14 which provides select, drag, and drop functionality 15 to pull incoming messages and to enable selection of an option between “Students” and “Groups.” The processor 16 also implements source determination functionality to identify the source of an incoming message. The option determination functionality of the processor 26 determines a category to which an incoming message belongs based on the source identity. For example, the option functionality may discern between “Group” messages and “Student” messages. The interface 40 may interface with the messaging categorization functionality of an existing messaging program such as iMessage® and SMS/MMS.

Shown in FIG. 7 is a view of the student ‘ELocker’ screen 710 including a plurality of contained folders 712 which may be accessed by selecting the ‘ELocker’ categorized folder 650. In this particular example, the contained folders 712 include “Report Card,” “College Data,” and “Other Documents.” Each of the contained folders 712 may be accessed by pressing on the contained folder 712 using the GUI 14. Each of the categorized folder 712 includes the “<” 716 indicators to notify the student user more files are available for viewing.

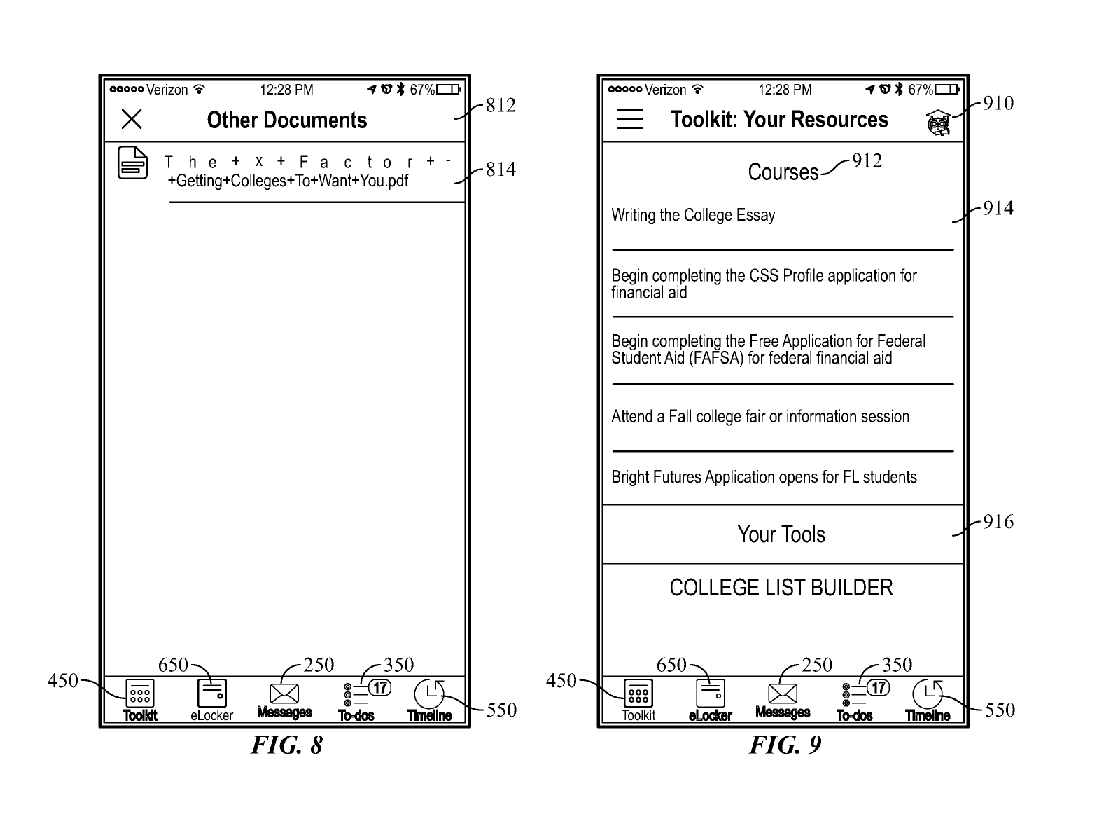

Shown in FIG. 8 is an example of a further contained downloaded file “The+x+Factor+-+Getting+Colleges+To+Want+You.pdf.” 812 contained within the folder “Other Documents” 814. The student user may select the downloaded file 812 which is viewable through the display 12.

Shown in FIG. 9 is a view of the student ‘Toolkit’ screen 910 which is accessible by selecting the categorized folder ‘Toolkit’ 450 on the screen which provides a list of student user academic resources designed to aid the student in the college/university selection and application process. Further included in this course list are detailed information and resources for applying for financial aid, scholarships, loan information, and eligibility. In this particular example, a list of “Courses” 912 is provided in a scrollable vertical list which is student user-specific based on the pre-programmed academic profile. To select the course “Writing the College Essay” 914, the user would simply select the desired course from the list presented. Located below the listed “Courses” is the “Your Tools” 916 section which allows the student to research and build a list of interested institutions including programs and majors, admissions considerations, campus life information, etc. The student user may be able to store helpful tools with essential information about particular college/university costs, graduation rates, and the average amount of student debt while simultaneously comparing institutions for consideration.

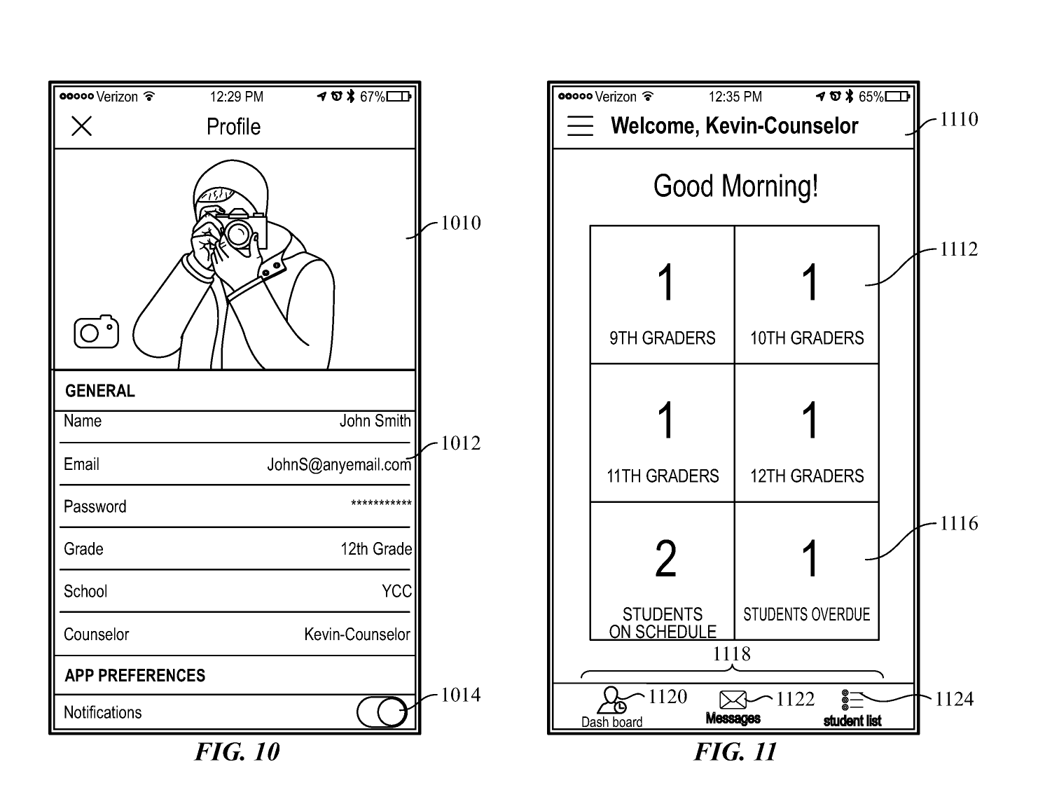

Shown in FIG. 10 is a view of the student ‘Profile’ screen 1010 which allows the student user to input general contact information 1012 including name, email, academic grade level, school, photograph, and counselor. In the particular example, illustrated, “John Smith” is in 12^{th} grade and assigned to “Kevin-Counselor.” The GUI 14 functionality further allows the student user to transition a “Notifications” button 1014 located at the bottom of the screen between the on/off position if they desire to have notifications, including push-notifications, sent to their profile.

Shown in FIG. 11 is a view of the counselor ‘Dashboard’ screen 1110 which includes a list of student users sorted according to academic grade level 1114 and sub-categorized by “Students on Schedule” or “Students Overdue” 1116. The ‘Dashboard’ screen 1110 further includes a plurality of counselor categorized folders including ‘Dashboard’ 1120, ‘Messages’ 1122, and ‘Student Lists’ 1124 each with its icon. The counselor may shift between categorized folders 1118 by simply pressing on the icon corresponding to the desired counselor categorized folder on their mobile device screen.

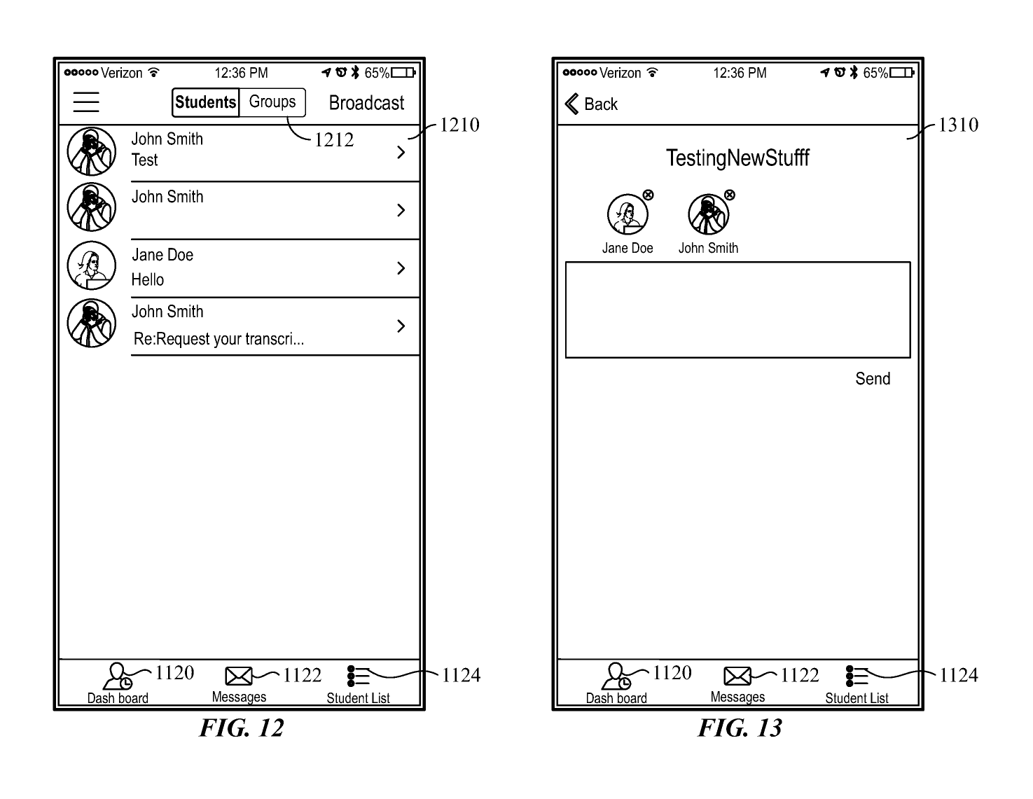

Shown in FIG. 12 is a view of the counselor ‘Messaging” screen 1210 with the ‘Student” options 1212 selected to enable a group messaging thread further illustrated in FIG. 13 1310. In the particular example provided in FIG. 13, a group messaging thread or new conversation is created and will be sent by first opening a “message” and tapping on the student user or selecting “add contact” to create a list of recipients (i.e., named group). Once this “group” is selected and/or named, the counselor may tap on the “send” button to transmit the message. It is contemplated the messaging is compatible with existing group messages such as iMessage, group MMS, and group SMS based on the recipient's settings, network connection, and wireless carrier. It is further contemplated all transmitted messages are protected using end-to-end encryption.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the block diagram, and combinations of blocks in the block diagram, can be implemented by computer program instructions. These computer program instructions may be provided to a microprocessor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory or storage medium that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block diagram block or blocks.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A system for providing college preparatory academic counseling in a non-transitory computer-readable medium to a student user, the system comprising:
a processor in communication with a memory module and configured to:
provide a unique student profile to the student user based on a received input from an admin authorized counselor;
assign a pre-determined academic profile to the student user, the pre-determined academic profile corresponding to a pre-determined academic grade;
enable electronic messaging between the student user and a counselor designated by an authorized system administrator;
display a plurality of categorized folders having a plurality of academic task/milestones based on the assigned pre-determined academic profile; and
a memory module configured to store a plurality of academic data including:
a plurality of user specific logins including an access level designated by an authorized system administrator;
a plurality of pre-determined academic profiles;
a plurality of viewable academic media files further including at least a financial profile of a college/university; and
a Graphical User Interface configured to:
allow a user to view a set of contents in a selectable folder by selecting a unique icon corresponding to the folder;
enable the student user to drop and drag to a customized list at least one desired college/university from a plurality of college/universities within the memory module.

2. The system of claim 1, wherein the plurality of categorized folders includes a ‘Toolkit’ categorized folder including at least one assigned course from the assigned pre-determined academic profile.

3. The system of claim 2, wherein the ‘Toolkit’ categorized folder further allows a user to apply a filter from a list of colleges/universities wherein the filter includes at least:
a geographic region;
a state; and
a percentage of financial aid offered.

4. The system of claim 1, wherein the plurality of categorized folders includes an ‘ELocker’ categorized folder including a student user downloaded file.

5. The system of claim 4, wherein the ‘ELocker’ categorized folder includes a plurality of academic media files and tutorials.

6. The system of claim 1, wherein the plurality of categorized folders includes a ‘Messages’ folder configured to allow a “Group” messaging thread.

7. The system of claim 1, wherein the plurality of categorized folders includes a ‘To-dos’ categorized folder including a list of tasks assigned and based on the pre-determined academic profile and displayable in a scrollable vertical column.

8. The system of claim 7, wherein the ‘To-dos’ categorized folder is further configured to display at least one completed task from the list of tasks assigned and based on the pre-determined academic profile.

9. The system of claim 1, wherein the plurality of categorized folder includes a ‘Timeline’ categorized folder including a viewable calendar.

10. The system of claim 9, wherein the viewable calendar is configured to provide a notification on a date containing academic milestones having a defined due date and based on the pre-determined academic profile.

11. The system of claim 10, wherein the calendar is further configured to enable a student user to add at least one customized event to the calendar which is viewable in a vertically oriented ‘list of tasks” displayed in a ‘Timeline’ categorized folder.

12. The system of claim 1, further configured to provide a counselor dashboard including a displayable view of at least one assigned student user.

13. A system for providing college preparatory academic counseling between a student user and a counselor in a non-transitory computer-readable medium, the system comprising:
a processor in communication with a memory module and configured to:
provide a unique student user profile to the student user including an assigned academic counselor;
assign the student user a pre-determined academic profile including based on an academic grade level of the student user displayable in a plurality of categorized folders;
provide electronic messaging between the student user and the academic counselor;
enable a viewable calendar having a plurality of academic milestones including a due date based on the assigned pre-determined academic profile of the student user; and
a memory module configured to store:
a plurality of downloaded academic files received from the student user or the academic counselor;
at least one viewable media file including an academic tutorial;
a list of college/university profiles including a schedule of financial aid information;
a student user desired college/university profile selected from the list of college/university profiles; and
a Graphical User Interface configured to:
allow the student user to view a downloaded file in a categorized folder by selecting the downloaded file; and
enable the student user to drop and drag the student user desired college/university into a customized folder.

14. The system of claim 13, wherein each of the plurality of categorized folders includes a unique icon displayable on at least the student user profile.

15. The system of claim 13, further configured to provide a system authorized participant a unique login and view a portion of the academic profile of the student user.

16. The system of claim 13, further including a mobile application server.

17. The system of claim 13, wherein the plurality of categorized folders includes:
a ‘Toolkit’ categorized folder;
an ‘ELocker’ categorized folder;
a ‘Messages’ categorized folder;
a ‘To-dos’ categorized folder; and
a ‘Timeline’ categorized folder.

18. The system of claim 17, wherein the ‘timeline’ categorized folder includes a calendar configured to provide a selectable chronologically numbered notification corresponding to an assigned task.

19. The system of claim 17, wherein the ‘ELocker’ categorized folder includes a plurality of student user specific academic files including;
a report card;
a standardized test score; and
an academic tutorial.

20. A method of providing academic counseling resources to an academic counselor and a student user using a mobile device:
generating a unique login and profile to the student user from a system authorized administrator;
assigning a pre-defined academic profile corresponding to a pre-determined academic student to student user;
providing a plurality of selectable folder associated with the pre-defined academic profile;
displaying an incoming electronic message from an admin authorized participant;
providing a list of academic events by selecting one of the plurality of selectable folders;
providing at least one academic task viewable on a calendar and wherein a visual notification is provided on a calendar date having an academic task; and
enabling a user to scroll in a vertical position between a plurality of downloaded files in a list and stored within one of the plurality of selectable folders.
